(19) United States
(12) Patent Application Publication
(10) Pub. No.: US 2025/0157148 A1
(43) Pub. Date: May 15, 2025

(54) TEXTURED MESH RECONSTRUCTION FROM MULTI-VIEW IMAGES

(71) Applicant: QUALCOMM Incorporated, San Diego, CA (US)

(72) Inventors: Chieh-Ming KUO, Taoyuan (TW); Ke-Li CHENG, San Diego, CA (US); Yan DENG, La Jolla, CA (US); Kuang-Man HUANG, Zhubei City (TW); Michel Adib SARKIS, San Diego, CA (US)

(21) Appl. No.: 18/509,041

(22) Filed: Nov. 14, 2023

(51) Int. Cl. G06T 17/20; G06V 40/16

(52) U.S. Cl. CPC G06T 17/20; G06V 40/168

(57) ABSTRACT

Techniques and systems are provided for generating a representation of a face. For instance, a process can include obtaining a plurality of images of a face, extracting features for each image of the plurality of images to generate a plurality of feature maps and fusing the plurality of feature maps based on features of the plurality of feature maps along a common axis to generate an aligned feature map.

### FIELD

The present disclosure generally relates to systems and techniques for generating three-dimensional (3D) models. For example, aspects of the present disclosure relate to performing topologically textured mesh reconstruction from multi-view images.

### BACKGROUND

Many devices and systems allow a scene to be captured by generating frames (also referred to as images) and/or video data (including multiple images or frames) of the scene. For example, a camera or a computing device including a camera (e.g., a mobile device such as a mobile telephone or smartphone including one or more cameras) can capture a sequence of frames of a scene. The frames and/or video data can be captured and processed by such devices and systems (e.g., mobile devices, IP cameras, etc.) and can be output for consumption (e.g., displayed on the device and/or other device). In some cases, the frame and/or video data can be captured by such devices and systems and output for processing and/or consumption by other devices.

A frame can be processed (e.g., using object detection, recognition, segmentation, etc.) to determine objects that are present in the frame, which can be useful for many applications. For instance, a model can be determined for representing an object in a frame and can be used to facilitate effective operation of various systems. Examples of such applications and systems include augmented reality (AR), robotics, automotive and aviation, three-dimensional scene understanding, object grasping, object tracking, in addition to many other applications and systems.

### SUMMARY

Systems and techniques are described herein for generating a textured a three-dimensional (3D) facial model. In one illustrative example, a method for generating a representation of a face is provided. The method includes: obtaining a plurality of images of a face, extracting features for each image of the plurality of images to generate a plurality of feature maps, and fusing the plurality of feature maps based on features of the plurality of feature maps along a common axis to generate an aligned feature map.

As another example, an apparatus for generating a representation of a face is provided. The apparatus includes at least one memory and at least one processor coupled to the at least one memory. The at least one processor is configured to: obtain a plurality of images of a face; extract features for each image of the plurality of images to generate a plurality of feature maps; and fuse the plurality of feature maps based on features of the plurality of feature maps along a common axis to generate an aligned feature map.

In another example, a non-transitory computer-readable storage medium comprising instructions stored thereon is provided. The instructions, when executed by at least one processor, causes the at least one processor to: obtain a plurality of images of a face; extract features for each image of the plurality of images to generate a plurality of feature maps; and fuse the plurality of feature maps based on features of the plurality of feature maps along a common axis to generate an aligned feature map.

As another example, an apparatus for generating a representation of a face is provided. The apparatus includes: means for obtaining a plurality of images of a face; means for extracting features for each image of the plurality of images to generate a plurality of feature maps; and means for fusing the plurality of feature maps based on features of the plurality of feature maps along a common axis to generate an aligned feature map.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an architecture for generating a UV aligned feature map, in accordance with aspects of the present disclosure.

FIG. 2 illustrates an architecture for generating intermediate residual position map, in accordance with aspects of the present disclosure.

FIG. 3 illustrates an architecture for generating a fine residual position map, in accordance with aspects of the present disclosure.

FIG. 4 is a flow diagram illustrating a process for animating a representation of a face, in accordance with aspects of the present disclosure.

FIG. 5 is an illustrative example of a deep learning neural network that can be used by a 3D model training system.

FIG. 6 is an illustrative example of a convolutional neural network (CNN).

FIG. 7 is a diagram illustrating an example of a system for implementing certain aspects of the present technology.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The generation of three-dimensional (3D) models for physical objects can be useful for many systems and applications, such as for extended reality (XR) (e.g., including augmented reality (AR), virtual reality (VR), mixed reality (MR), etc.), robotics, automotive, aviation, 3D scene understanding, object grasping, object tracking, in addition to many other systems and applications. In AR environments, for example, a user may view images (also referred to as frames) that include an integration of artificial or virtual graphics with the user's natural surroundings. AR applications allow real images to be processed to add virtual objects to the images or to display virtual objects on a see-through display (so that the virtual objects appear to be overlaid over the real-world environment). AR applications can align or register the virtual objects to real-world objects (e.g., as observed in the images) in multiple dimensions. For instance, a real-world object that exists in reality can be represented using a model that resembles or is an exact match of the real-world object. In one example, a model of a virtual airplane representing a real airplane sitting on a runway may be presented by the display of an AR device (e.g., AR glasses, AR head-mounted display (HMD), or other device) while the user continues to view his or her natural surroundings through the display. The viewer may be able to manipulate the model while viewing the real-world scene. In another example, an actual object sitting on a table may be identified and rendered with a model that has a different color or different physical attributes in the AR environment. In some cases, artificial virtual objects that do not exist in reality or computer-generated copies of actual objects or structures of the user's natural surroundings can also be added to the AR environment.

There is an increasing number of applications that use face data (e.g., for XR systems, for 3D graphics, for security, among others), leading to a large demand for systems with the ability to generate detailed 3D face models (as well as 3D models of other objects) in an efficient and high-quality manner. There also exists a large demand for generating 3D models of other types of objects, such as 3D models of vehicles (e.g., for autonomous driving systems), 3D models of room layouts (e.g., for XR applications, for navigation by devices, robots, etc.), among others. Generating a detailed 3D model of an object (e.g., a 3D face model) typically requires expensive equipment and multiple cameras in an environment with controlled lighting, which hinders large-scale data collection.

Performing 3D object reconstruction (e.g., to generate a 3D model of an object, such as a face model) from one or more images can be challenging. Using a face as an illustrative example of a 3D object, 3D face reconstruction can be difficult based on the need to reconstruct the face geometry (e.g., shape) and the facial expression. In addition, it can be difficult to accurately reconstruct facial expressions for portions of the face that can experience high variations in appearance. In one illustrative example, the eyes of a face can be moved to extreme gaze directions (e.g., looking for to one side, crossing eyes, or the like). In another illustrative example, the upper and lower lips of the mouth of a face are controlled by muscles that allow a large variety of difficult to reconstruct mouth shapes (e.g., smiling, frowning, baring teeth, twisting lips, etc.).

In some implementations, a highly detailed 3D facial model (not shown) can be generated using expensive camera equipment that captures an individual's face from multiple angles. In some cases, the 3D facial model can also be manually edited by skilled artists to product an accurate depiction of an individual. The process of generating such a highly detailed 3D facial model results in only a single model for the specific individual and does not provide a flexible frame-work for generating 3D models for any individual without advanced preparation of the detailed 3D facial model. Further, use of structured local features to de-normalize global features for texture synthesis may be relatively computationally expensive.

Systems and techniques for generating accurate topological 3D facial models for users without manual work may be useful. Topological meshes may be useful for a wide range of industries, including gaming, animation, and so forth. A topological mesh may be a representation of a 3D object using vertices and polygons where the vertices have a defined point on a corresponding object. For example, a topological mesh model of a face may include a specific vertex point which corresponds to a tip of a nose of a person. Other vertex points may correspond with part of an ear, lips, etc., and the location of these vertex points define the shape of the 3D object. Generally, traditional capture systems generate a dense mesh based on images, rather than a topological mesh and the topological mesh may be generated from the dense mesh using retopology software to process the mesh. Often, manual annotation may also be used, for example, to help identify, align, position vertices with their respective locations for an object. Thus, techniques to quickly automatically generate topological meshes may be useful.

In some cases, a topological mesh may be generated using a feature aligned multi-resolution feature maps. The feature aligned multi-resolution feature map may be a map of features detected in images at multiple resolutions that have been aligned to a common axis, such as a UV axis of UV space. The U in the UV space and the V in the UV space can denote the axes of the UV face position map (e.g., the axes of a 2D texture of the face). In one illustrative example, the U in the UV space can denote a first axis (e.g., a horizontal X-axis) of the UV face position map and the V in the UV space can denote a second axis (e.g., a vertical Y-axis) of the UV space.

Features of a set of images of an object, such as a user's head, may be detected from a set of images taken of the object. Feature maps for the detected features may be aligned on a common axis, such as the UV axis. The feature maps for the set of images may be merged (e.g., fused) into a single UV aligned feature map. The UV aligned feature map may be input to a predictor along with a mean face position map. The mean face position map may be 2D projection of a generic (e.g., mean, default) 3D mesh model of the object. Correspondences between features of the UV aligned feature map and the mean face position map may be determined to generate displacement values. The displacement values may indicate how far and in what direction a particular vertex of the mean face position map should be moved to align the vertex with a pixel of the corresponding feature. The displacement values may be applied (e.g., summed into) the mean face position map to distort the mean face position map to better match the detected features. This alignment of the UV aligned feature map and face position maps may be repeated any number of times to refine the alignments and generate a fine position map. The fine position map may then be reprojected into 3D space as a part of the representation of the object.

Various aspects of the application will be described with respect to the figures.

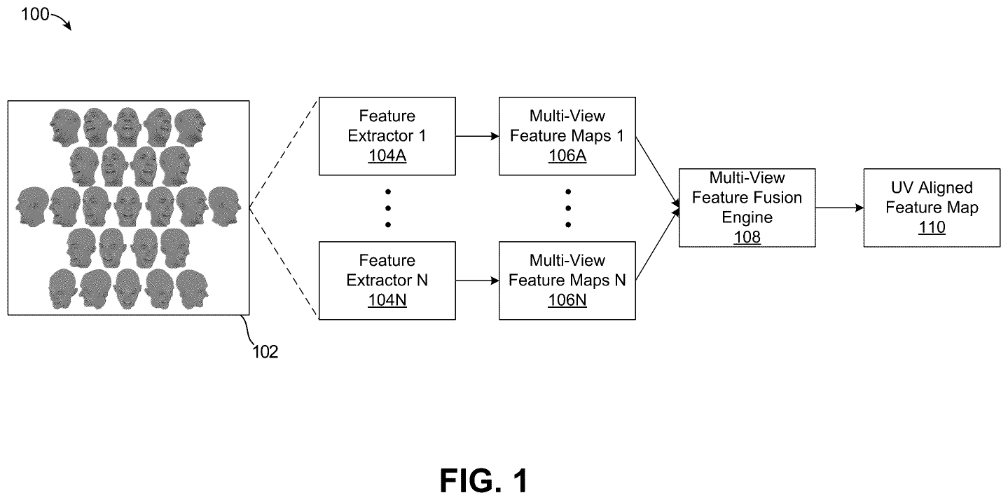

FIG. 1 illustrates an architecture 100 for generating a UV aligned feature map, in accordance with aspects of the present disclosure. As shown in FIG. 1, the UV aligned feature map may be generated based on a set of images 102 of an object, such as a head of a person. Images of the set of images 102 may provide multiple views of the object. In some cases, the images may provide views from different angles around the object (though certain portions of the object may not captured in the images (e.g., occluded, shaded, limited view angles, etc.)). Of note, while described in the context of a head, it may be understood that techniques discussed herein may be applied to any object. The images of the set of images 102 may be passed into a set of feature extractors 104A . . . 104N (collectively, set of feature extractors 104). The set of feature extractors 104 may include one or more feature extractors for obtaining features from the images of the set of images 102. In some cases, the features may be extracted in two dimensions (e.g., the feature extractors may be 2D feature extractors). In some cases, the feature extractors of the set of feature extractors 104 may include one or more convolutional networks, such as a deep convolution network (DCN). As an example, as discussed below, the DCN may output probabilities that an input data, such as images of the set of images 102, includes certain features. The DCN may then be adjusted to extract (e.g., output) relevant features. In some cases, a set of DCNs may function as feature extractors of the set of feature extractors 104 to identify features in images. The set of feature extractors 104 may extract features from the images of the set of images 102 to generate multi-view features maps 106A . . . 106N (collectively multi-view feature maps 106). The multi-view feature maps 106 may be maps (e.g., pixels of the images labeled with features corresponding to the pixels) of features the images of set of images 102 from the multiple views. The multi-view feature maps 106 may be passed to a multi-view feature fusion engine 108.

The multi-view feature fusion engine 108 may align and fuse the multi-view feature maps 106 to generate a UV aligned feature map 110. For example, the multi-view feature fusion engine 108 may use features of the feature maps to align the multiple feature maps on common axes, such as a UV axis, to generate a highly detailed, UV aligned feature map 110. The UV aligned feature map 110 may represent features from the images of the set of images 102, allowing points (e.g., pixels) of the UV aligned feature map 110 to be super sampled. In some examples, multiple features for a particular pixel of the UV aligned feature map 110 may be fused into a single feature. In some cases, the UV aligned feature map 110 may include features from all of the images of the set of images 102. In some cases, the multi-view feature fusion engine 108 may also align textures of the images of the set of images 102 based on the alignment of the multiple feature maps to generate a texture map for the face.

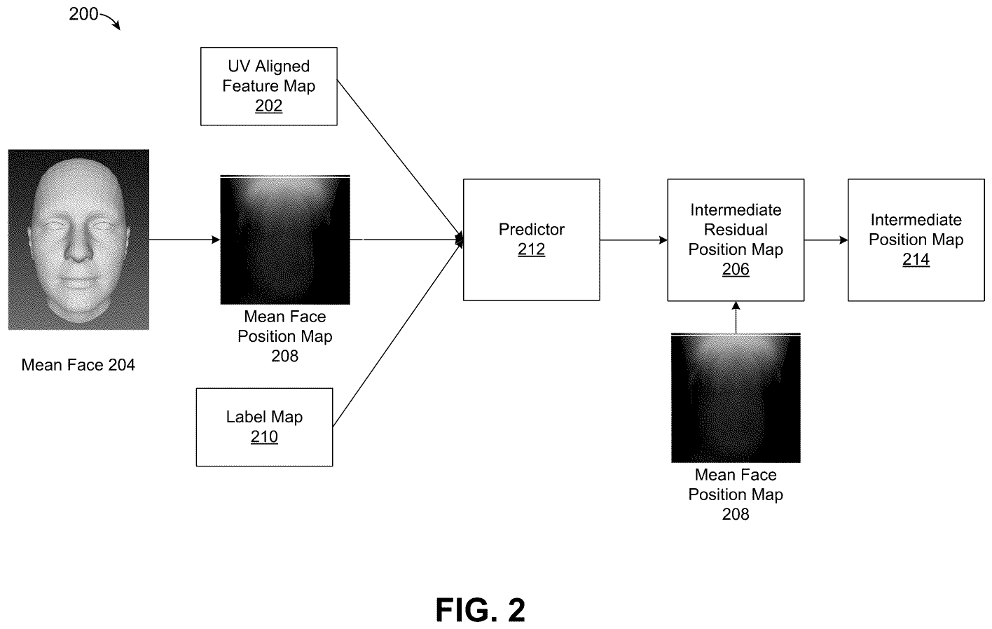

FIG. 2 illustrates an architecture 200 for generating intermediate residual position map, in accordance with aspects of the present disclosure. As shown in FIG. 2, a UV aligned feature map 202, such as UV aligned feature map 110 of FIG. 1, may be combined with a mean face 204 to generate an intermediate residual position map 206 (e.g., intermediate topological mesh). In some cases, the mean face 204 may be a 3D morphable model (3DMM) that represents the geometry of a default or generic head/face. In some cases, the mean face 204 may be a default (e.g., generic) 3DMM that may be morphed into a likeness of the user. The mean face 204 may be a topological mesh and the mean face 204 may be sampled into the UV coordinate system such that each 3D vertex of the mean face 204 is flattened into a 2D UV space to generate a mean face position map 208. In some cases, the mean face 204 may be projected into the UV space such that the mean face position map 208 is aligned with a same origin as for the UV aligned feature map 202. For example, if an origin (e.g., 0,0 in UV space) is defined as the tip of a nose, both the mean face position map 208 and the UV aligned feature map 202 may be aligned so a vertex and feature (respectively) corresponding with the tip of the nose is at the origin in UV space. The mean face position map 208, UV aligned feature map 202, and a label map 210 may be input to a predictor 212.

In some cases, the label map 210 may be a UV map (e.g., corresponding to the mean face position map 208) where pixels of the UV map include a number indicating what a particular portion of the UV map corresponds to for the object. For example, a portion of the label map 210 may be labeled to indicate that this portion of the label map 210 may correspond to a nose, another portion may correspond to the right eye, another portion may correspond to the left eye, and so forth. In some cases, the label map 210 may be integrated with the mean face position map 208. For example, the label map 210 may be a layer of or labels for the mean face position map 208.

The predictor 212 may use the UV aligned feature map 202 and label map 210 to align vertices of the mean face position map 208 to corresponding pixels of the UV aligned feature map 202. In some cases, the predictor 212 may determine correspondences between certain detected features in the UV aligned feature map 202 with certain vertices of the mean face position map 208, for example, by using the labels of the label map 210. This alignment may be performed on a pixel by pixel level as between the UV aligned feature map 202 and mean face position map 208. The correspondences may be expressed as displacement values for the vertices of the mean face 204 in UV space. For example, the displacement values may indicate how a particular vertex may be moved to align the vertex with the corresponding pixel of a feature. The displacement values (e.g., a set of displacement values) may be included in the intermediate residual position map 206.

In some examples, the intermediate residual position map 206 may be applied to (e.g., summed with) the mean face position map 208 to obtain an intermediate position map 214. For example, as discussed above, the mean face position map 208 may be a 2D projection of the mean face 204 in UV space, while the intermediate residual position map 206 indicates displacement values for vertices of the mean face 204 as represented by the mean face position map 208 in UV space. In some cases, the intermediate position map 214 may be further refined to improve the representation of the object.

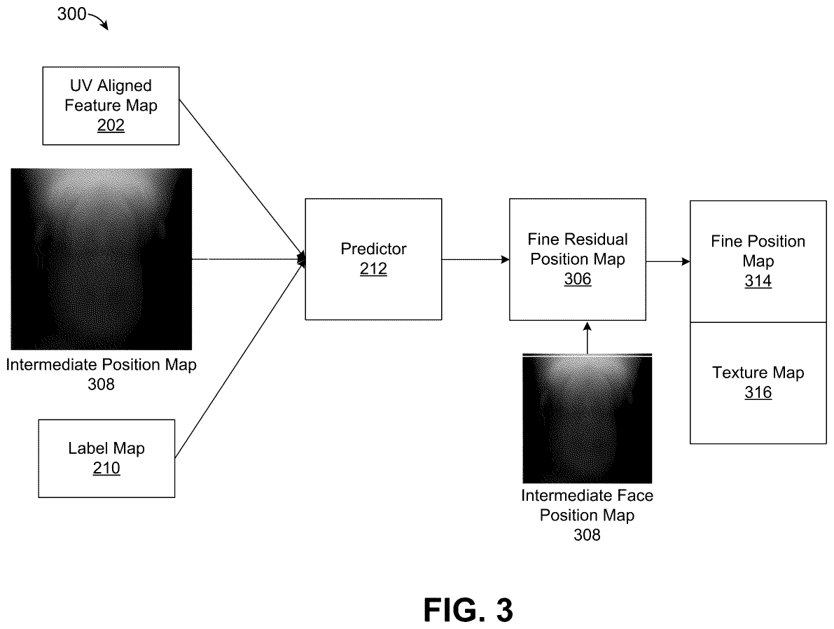

FIG. 3 illustrates an architecture 300 for generating a fine residual position map, in accordance with aspects of the present disclosure. In some cases, the architecture 300 is similar to architecture 200 of FIG. 2. In some cases, a single architecture may be used to generate both the intermediate residual position map and the fine residual position map based on the inputs to the architecture. As shown in FIG. 3, an intermediate position map 308, such as the intermediate position map 214 of FIG. 2, along with the UV aligned feature map 202 and the label map 210, both as from FIG. 2, may be input to a predictor 212, which may be the same as predictor 212 from FIG. 2. The predictor 212 may use the UV aligned feature map 202 and label map 210 to align vertices of the intermediate position map 308 to corresponding pixels of the UV aligned feature map 202 and generate a fine residual position map 306.

In some cases, the fine residual position map 306 may be applied to the intermediate position map 308 to obtain a fine position map 314. In some cases, the fine position map 314 may be further iteratively refined in a manner similar to the intermediate position map 308. In other cases, the fine position map 314 may be output along with a texture map 316. In some cases, the texture map 316 may be the texture map discussed above with respect to FIG. 1. The fine position map 314 may describe vertices of a fine face mesh projected into the 2D UV space. The fine position map 314 may be reprojected into 3D space to obtain a topological fine face mesh of the face captured by the images (e.g., of the set of images 102 of FIG. 1). The texture map 316 may then be applied to the fine face mesh to generate a representation of the face captured by the images (e.g., of the set of images 102 of FIG. 1).

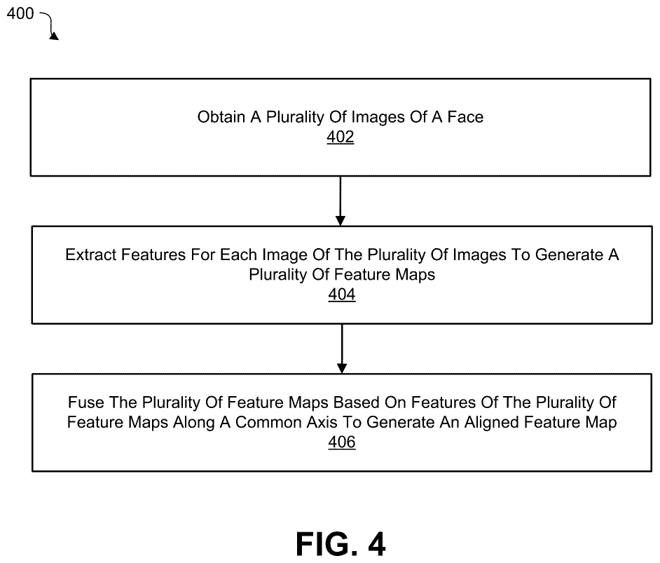

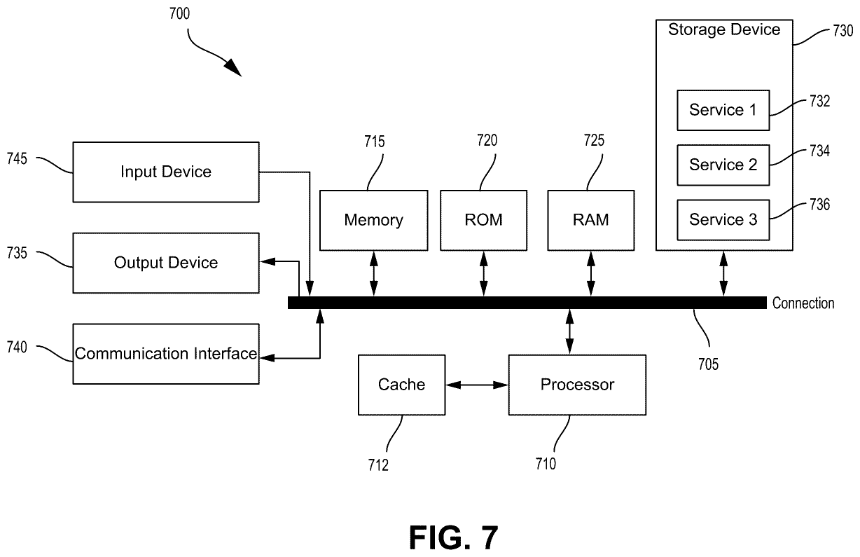

FIG. 4 is a flow diagram illustrating a process 400 for animating a representation of a face, in accordance with aspects of the present disclosure. The process 400 may be performed by a computing device (or apparatus) or a component (e.g., a chipset, codec, processor 710 of FIG. 7, etc.) of the computing device. The computing device may be a mobile device (e.g., a mobile phone, and the like), a network-connected wearable such as a watch, an extended reality (XR) device such as a virtual reality (VR) device or augmented reality (AR) device, a vehicle or component or system of a vehicle, or other type of computing device (e.g., computing system 700 of FIG. 7). The operations of the process 400 may be implemented as software components that are executed and run on one or more processors (e.g., processor 710 of FIG. 7, and the like). In some cases, the operations of the process 400 can be implemented by a system having the computing system 700 of FIG. 7.

At block 402, the computing device (or component thereof) may obtain a plurality of images (e.g., set of images 102 of FIG. 1) of a face. In some cases, the plurality of images of a face comprises views of the face from a plurality of angles around the face.

At block 404, the computing device (or component thereof) may extract features (e.g., by a set of feature extractors 104 of FIG. 1) for each image of the plurality of images to generate a plurality of feature maps (e.g., multi-view feature maps 106 of FIG. 1). In some cases, features for each image of the plurality of images are extracted using a set a machine learning based feature extractors.

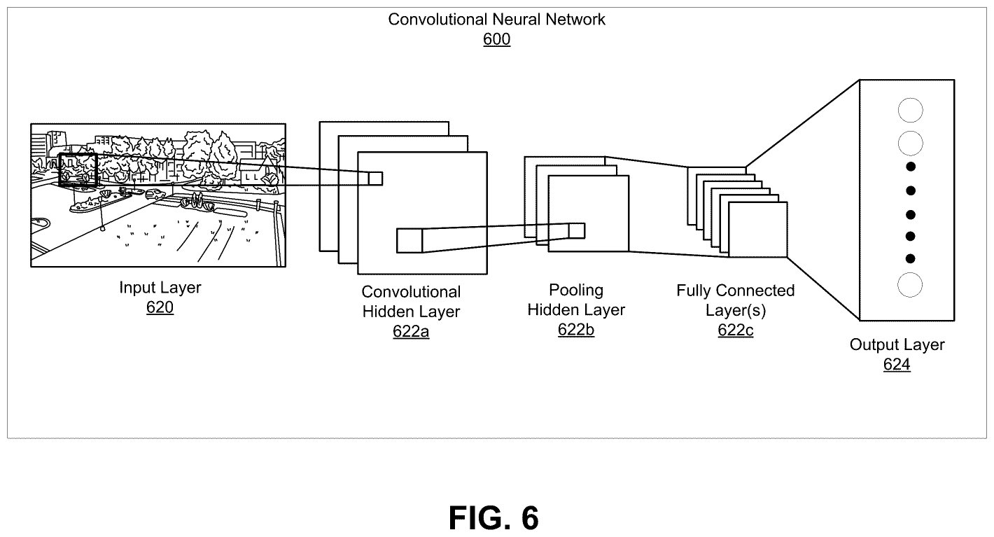

At block 406, the computing device (or component thereof) may fuse the plurality of feature maps (e.g., by a multi-view feature fusion engine 108 of FIG. 1) based on features of the plurality of feature maps along a common axis to generate an aligned feature map (e.g., UV aligned feature map 110 of FIG. 1). In some examples, the common axis comprise a U, V axis. In some cases, the computing device (or component thereof) may obtain a generic 3D morphable model (3DMM) of a face (e.g., mean face 204 of FIG. 2), the generic 3DMM including a plurality of vertices; project the generic 3DMM to two dimensions based on the common axis to generate a mean face position map (e.g. mean face position map 208 of FIG. 2); determine one or more correspondences between features of the aligned feature map and vertices of the mean face position map to generate a first residual position map (e.g., intermediate residual position map 206 of FIG. 6); and combine the first residual position map with the mean face position map to generate an intermediate position map (e.g., intermediate position map 214 of FIG. 2). In some examples, the computing device (or component thereof) may determine the one or more correspondences by determining one or more displacement values between features of the aligned feature map and vertices of the mean face position map, wherein the first residual position map includes the one or more displacement values. In some cases, the one or more correspondences are also determined based on a label map (e.g., label map 210 of FIG. 2) labeling portions of the mean face position map. In some examples, the computing device (or component thereof) may determine one or more correspondences between features of the aligned feature map and vertices of the intermediate position map (e.g., intermediate position map 308 of FIG. 3) to generate a second residual position map (e.g., fine residual position map 306 of FIG. 3); and combine the second residual position map with the intermediate position map to generate a fine position map (e.g., fine position map 314). In some cases, the computing device (or component thereof) may reproject the fine position map to three dimensions to obtain a fine face mesh. In some examples, the computing device (or component thereof) may align textures of the plurality of images based on the fusing of the plurality of feature maps to generate a texture map; and apply the texture map to the fine face mesh to obtain a representation of the face.

The computing device can include any suitable device, such as a mobile device (e.g., a mobile phone), a desktop computing device, a tablet computing device, an extended reality (XR) device or system (e.g., a VR headset, an AR headset, AR glasses, or other XR device or system), a wearable device (e.g., a network-connected watch or smartwatch, or other wearable device), a server computer or system, a vehicle or computing device of a vehicle (e.g., an autonomous vehicle), a robotic device, a television, and/or any other computing device with the resource capabilities to perform the processes described herein, including the process 400. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The process 400 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 400, and/or other processes described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

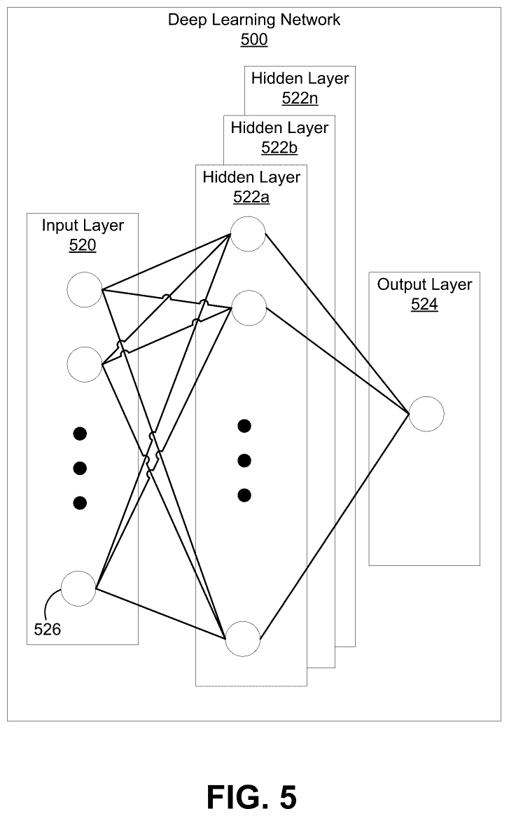

FIG. 5 is an illustrative example of a deep learning neural network 500 that can be used by a 3D model training system. An input layer 520 includes input data. In one illustrative example, the input layer 520 can include data representing the pixels of an input video frame. The neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. The neural network 500 further includes an output layer 524 that provides an output resulting from the processing performed by the hidden layers 522a, 522b, through 522n. In one illustrative example, the output layer 524 can provide a classification for an object in an input video frame. The classification can include a class identifying the type of object (e.g., a person, a dog, a cat, or other object).

The neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the hidden layers 522a, 522b, through 522n can transform the information of each input node by applying activation functions to the information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 524, at which an output is provided. In some cases, while nodes (e.g., node 526) in the neural network 500 are shown as having multiple output lines, a node has a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more objects. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 524. In an example in which the neural network 500 is used to identify objects in images, the neural network 500 can be trained using training data that includes both images and labels. For instance, training images can be input into the network, with each training image having a label indicating the classes of the one or more objects in each image (basically, indicating to the network what the objects are and what features they have). In one illustrative example, a training image can include an image of a number 2, in which case the label for the image can be [0 0 1 0 0 0 0 0 0 0].

In some cases, the neural network 500 can adjust the weights of the nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training images until the neural network 500 is trained well enough so that the weights of the layers are accurately tuned.

For the example of identifying objects in images, the forward pass can include passing a training image through the neural network 500. The weights are initially randomized before the neural network 500 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

For a first training iteration for the neural network 500, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 500 is unable to determine low level features and thus cannot make an accurate determination of what the classification of the object might be. A loss function can be used to analyze error in the output. Any suitable loss function definition can be used. One example of a loss function includes a mean squared error (MSE). The MSE is defined as

$${E}_{total} = \sum \frac{1}{2} {( target - output )}^{2} ,$$

which calculates the sum of one-half times the actual answer minus the predicted (output) answer squared. The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 500 can perform a backward pass by determining which inputs (weights) most contributed to the loss of the network, and can adjust the weights so that the loss decreases and is eventually minimized.

A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wi denotes the initial weight, and n denotes a learning rate. The learning rate can be set to any suitable value, with a high learning rate including larger weight updates and a lower value indicating smaller weight updates.

The neural network 500 can include any suitable deep network. One example includes a convolutional neural network (CNN), which includes an input layer and an output layer, with multiple hidden layers between the input and out layers. An example of a CNN is described below with respect to FIG. 5. The hidden layers of a CNN include a series of convolutional, nonlinear, pooling (for downsampling), and fully connected layers. The neural network 500 can include any other deep network other than a CNN, such as an autoencoder, a deep belief nets (DBNs), a Recurrent Neural Networks (RNNs), among others.

FIG. 6 is an illustrative example of a convolutional neural network (CNN 600). The input layer 620 of the CNN 600 includes data representing an image. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 622a, an optional non-linear activation layer, a pooling hidden layer 622b, and fully connected hidden layers 622c to get an output at the output layer 624. While only one of each hidden layer is shown in FIG. 6, one of ordinary skill will appreciate that multiple convolutional hidden layers, non-linear layers, pooling hidden layers, and/or fully connected layers can be included in the CNN 600. As previously described, the output can indicate a single class of an object or can include a probability of classes that best describe the object in the image.

The first layer of the CNN 600 is the convolutional hidden layer 622a. The convolutional hidden layer 622a analyzes the image data of the input layer 620. Each node of the convolutional hidden layer 622a is connected to a region of nodes (pixels) of the input image called a receptive field. The convolutional hidden layer 622a can be considered as one or more filters (each filter corresponding to a different activation or feature map), with each convolutional iteration of a filter being a node or neuron of the convolutional hidden layer 622a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 622a. Each connection between a node and a receptive field for that node learns a weight and, in some cases, an overall bias such that each node learns to analyze its particular local receptive field in the input image. Each node of the hidden layer 622a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 622a is due to each node of the convolutional layer being applied to its corresponding receptive field. For example, a filter of the convolutional hidden layer 622a can begin in the top-left corner of the input image array and can convolve around the input image. As noted above, each convolutional iteration of the filter can be considered a node or neuron of the convolutional hidden layer 622a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 622a.

For example, a filter can be moved by a step amount to the next receptive field. The step amount can be set to 1 or other suitable amount. For example, if the step amount is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 622a.

The mapping from the input layer to the convolutional hidden layer 622a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a step amount of 1) of a 28×28 input image. The convolutional hidden layer 622a can include several activation maps in order to identify multiple features in an image. The example shown in FIG. 6 includes three activation maps. Using three activation maps, the convolutional hidden layer 622a can detect three different kinds of features, with each feature being detectable across the entire image.

In some examples, a non-linear hidden layer can be applied after the convolutional hidden layer 622a. The non-linear layer can be used to introduce non-linearity to a system that has been computing linear operations. One illustrative example of a non-linear layer is a rectified linear unit (ReLU) layer. A ReLU layer can apply the function f(x)=max (0, x) to all of the values in the input volume, which changes all the negative activations to 0. The ReLU can thus increase the non-linear properties of the CNN 600 without affecting the receptive fields of the convolutional hidden layer 622a.

The pooling hidden layer 622b can be applied after the convolutional hidden layer 622a (and after the non-linear hidden layer when used). The pooling hidden layer 622b is used to simplify the information in the output from the convolutional hidden layer 622a. For example, the pooling hidden layer 622b can take each activation map output from the convolutional hidden layer 622a and generates a condensed activation map (or feature map) using a pooling function. Max-pooling is one example of a function performed by a pooling hidden layer. Other forms of pooling functions be used by the pooling hidden layer 622a, such as average pooling, L2-norm pooling, or other suitable pooling functions. A pooling function (e.g., a max-pooling filter, an L2-norm filter, or other suitable pooling filter) is applied to each activation map included in the convolutional hidden layer 622a. In the example shown in FIG. 6, three pooling filters are used for the three activation maps in the convolutional hidden layer 622a.

In some examples, max-pooling can be used by applying a max-pooling filter (e.g., having a size of 2×2) with a step amount (e.g., equal to a dimension of the filter, such as a step amount of 2) to an activation map output from the convolutional hidden layer 622a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 622a having a dimension of 24×24 nodes, the output from the pooling hidden layer 622b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 600.

The final layer of connections in the network is a fully-connected layer that connects every node from the pooling hidden layer 622b to every one of the output nodes in the output layer 624. Using the example above, the input layer includes 28×28 nodes encoding the pixel intensities of the input image, the convolutional hidden layer 622a includes 3×24×24 hidden feature nodes based on application of a 5×5 local receptive field (for the filters) to three activation maps, and the pooling layer 622b includes a layer of 3×12×12 hidden feature nodes based on application of max-pooling filter to 2×2 regions across each of the three feature maps. Extending this example, the output layer 624 can include ten output nodes. In such an example, every node of the 3×12×12 pooling hidden layer 622b is connected to every node of the output layer 624.

The fully connected layer 622c can obtain the output of the previous pooling layer 622b (which should represent the activation maps of high-level features) and determines the features that most correlate to a particular class. For example, the fully connected layer 622c layer can determine the high-level features that most strongly correlate to a particular class, and can include weights (nodes) for the high-level features. A product can be computed between the weights of the fully connected layer 622c and the pooling hidden layer 622b to obtain probabilities for the different classes. For example, if the CNN 600 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 624 can include an M-dimensional vector (in the prior example, M=10), where M can include the number of classes that the program has to choose from when classifying the object in the image. Other example outputs can also be provided. Each number in the N-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 7 is a diagram illustrating an example of a system for implementing certain aspects of the present technology. In particular, FIG. 7 illustrates an example of computing system 700, which can be for example any computing device making up internal computing system, a remote computing system, a camera, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 700 includes at least one processing unit (CPU or processor) 710 and connection 705 that couples various system components including system memory 715, such as read-only memory (ROM) 720 and random access memory (RAM) 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some aspects, a hardware service that performs a particular function can include the software component stored in a computer-readable medium in connection with the necessary hardware components, such as processor 710, connection 705, output device 735, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, mobile phones (e.g., smartphones or other types of mobile phones), tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the present disclosure include:

Aspect 1. A method for generating a representation of a face, the method comprising: obtaining a plurality of images of a face; extracting features for each image of the plurality of images to generate a plurality of feature maps; and fusing the plurality of feature maps based on features of the plurality of feature maps along a common axis to generate an aligned feature map.

Aspect 2. The method of Aspect 1, further comprising: obtaining a generic 3D morphable model (3DMM) of a face, the generic 3DMM including a plurality of vertices; projecting the generic 3DMM to two dimensions based on the common axis to generate a mean face position map; determining one or more correspondences between features of the aligned feature map and vertices of the mean face position map to generate a first residual position map; and summing the first residual position map with the mean face position map to generate an intermediate position map.

Aspect 3. The method of Aspect 2, wherein determining the one or more correspondences comprises determining one or more displacement values between features of the aligned feature map and vertices of the mean face position map, and wherein the first residual position map includes the one or more displacement values.

Aspect 4. The method of any of Aspects 2-3, wherein the one or more correspondences are also determined based on a label map labeling portions of the mean face position map.

Aspect 5. The method of any of Aspects 2-4, further comprising: determining one or more correspondences between features of the aligned feature map and vertices of the intermediate position map to generate a second residual position map; and summing the second residual position map with the intermediate position map to generate a fine position map.

Aspect 6. The method of Aspect 5, further comprising reprojecting the fine position map to three dimensions to obtain a fine face mesh.

Aspect 7. The method of Aspect 6, further comprising: aligning textures of the plurality of images based on the fusing of the plurality of feature maps to generate a texture map; and applying the texture map to the fine face mesh to obtain a representation of the face.

Aspect 8. The method of any of Aspects 1-7, wherein the common axis comprise a U, V axis.

Aspect 9. The method of any of Aspects 1-8, plurality of images of a face comprises views of the face from a plurality of angles around the face.

Aspect 10. The method of any of Aspects 1-9, wherein features for each image of the plurality of images are extracted using a set a machine learning based feature extractors.

Aspect 11. An apparatus for generating a representation of a face, the apparatus comprising: at least one memory; and at least one processor coupled to the at least one memory and configured to: obtain a plurality of images of a face; extract features for each image of the plurality of images to generate a plurality of feature maps; and fuse the plurality of feature maps based on features of the plurality of feature maps along a common axis to generate an aligned feature map.

Aspect 12. The apparatus of Aspect 11, wherein the at least one processor is further configured to: obtain a generic 3D morphable model (3DMM) of a face, the generic 3DMM including a plurality of vertices; project the generic 3DMM to two dimensions based on the common axis to generate a mean face position map; determine one or more correspondences between features of the aligned feature map and vertices of the mean face position map to generate a first residual position map; and sum the first residual position map with the mean face position map to generate an intermediate position map.

Aspect 13. The apparatus of Aspect 12, wherein, to determine the one or more correspondences, the at least one processor is further configured to determine one or more displacement values between features of the aligned feature map and vertices of the mean face position map, and wherein the first residual position map includes the one or more displacement values.

Aspect 14. The apparatus of any of Aspects 12-13, wherein the one or more correspondences are also determined based on a label map labeling portions of the mean face position map.

Aspect 15. The apparatus of any of Aspects 12-14, wherein the at least one processor is further configured to: determine one or more correspondences between features of the aligned feature map and vertices of the intermediate position map to generate a second residual position map; and sum the second residual position map with the intermediate position map to generate a fine position map.

Aspect 16. The apparatus of Aspect 15, wherein the at least one processor is further configured to reproject the fine position map to three dimensions to obtain a fine face mesh.

Aspect 17. The apparatus of Aspect 16, wherein the at least one processor is further configured to: align textures of the plurality of images based on the fusing of the plurality of feature maps to generate a texture map; and apply the texture map to the fine face mesh to obtain a representation of the face.

Aspect 18. The apparatus of any of Aspects 11-17, wherein the common axis comprise a U, V axis.

Aspect 19. The apparatus of any of Aspects 11-18, wherein the plurality of images of a face comprises views of the face from a plurality of angles around the face.

Aspect 20. The apparatus of any of Aspects 11-19, wherein features for each image of the plurality of images are extracted using a set a machine learning based feature extractors.

Aspect 21. A non-transitory computer-readable storage medium comprising instructions stored thereon which, when executed by at least one processor, causes the at least one processor to: obtain a plurality of images of a face; extract features for each image of the plurality of images to generate a plurality of feature maps; and fuse the plurality of feature maps based on features of the plurality of feature maps along a common axis to generate an aligned feature map.

Aspect 22. The non-transitory computer-readable storage medium of Aspect 21, wherein the instructions cause the at least one processor to: obtain a generic 3D morphable model (3DMM) of a face, the generic 3DMM including a plurality of vertices; project the generic 3DMM to two dimensions based on the common axis to generate a mean face position map; determine one or more correspondences between features of the aligned feature map and vertices of the mean face position map to generate a first residual position map; and sum the first residual position map with the mean face position map to generate an intermediate position map.

Aspect 23. The non-transitory computer-readable storage medium of Aspect 22, wherein, to determine the one or more correspondences, the instructions cause the at least one processor to determine one or more displacement values between features of the aligned feature map and vertices of the mean face position map, and wherein the first residual position map includes the one or more displacement values.

Aspect 24. The non-transitory computer-readable storage medium of any of Aspects 22-23, wherein the one or more correspondences are also determined based on a label map labeling portions of the mean face position map.

Aspect 25. The non-transitory computer-readable storage medium of any of Aspects 22-24, wherein the instructions cause the at least one processor to: determine one or more correspondences between features of the aligned feature map and vertices of the intermediate position map to generate a second residual position map; and sum the second residual position map with the intermediate position map to generate a fine position map.

Aspect 26. The non-transitory computer-readable storage medium of Aspect 25, wherein the instructions cause the at least one processor to reproject the fine position map to three dimensions to obtain a fine face mesh.

Aspect 27. The non-transitory computer-readable storage medium of Aspect 26, wherein the instructions cause the at least one processor to: align textures of the plurality of images based on the fusing of the plurality of feature maps to generate a texture map; and apply the texture map to the fine face mesh to obtain a representation of the face.

Aspect 28. The non-transitory computer-readable storage medium of any of Aspects 21-27, wherein the common axis comprise a U, V axis.

Aspect 29. The non-transitory computer-readable storage medium of any of Aspects 21-28, wherein the plurality of images of a face comprises views of the face from a plurality of angles around the face.

Aspect 30. The non-transitory computer-readable storage medium of any of Aspects 21-29, wherein features for each image of the plurality of images are extracted using a set a machine learning based feature extractors.

Aspect 31. An apparatus for processing video data, comprising one or more means for performing one or more of operations according to any of Aspects 1-10.

What is claimed is:

1. A method for generating a representation of a face, the method comprising:
obtaining a plurality of images of a face;
extracting features for each image of the plurality of images to generate a plurality of feature maps; and
fusing the plurality of feature maps based on features of the plurality of feature maps along a common axis to generate an aligned feature map.

2. The method of claim 1, further comprising:
obtaining a generic 3D morphable model (3DMM) of a face, the generic 3DMM including a plurality of vertices;
projecting the generic 3DMM to two dimensions based on the common axis to generate a mean face position map;
determining one or more correspondences between features of the aligned feature map and vertices of the mean face position map to generate a first residual position map; and
combining the first residual position map with the mean face position map to generate an intermediate position map.

3. The method of claim 2, wherein determining the one or more correspondences comprises determining one or more displacement values between features of the aligned feature map and vertices of the mean face position map, and wherein the first residual position map includes the one or more displacement values.

4. The method of claim 2, wherein the one or more correspondences are also determined based on a label map labeling portions of the mean face position map.

5. The method of claim 2, further comprising:
determining one or more correspondences between features of the aligned feature map and vertices of the intermediate position map to generate a second residual position map; and
combining the second residual position map with the intermediate position map to generate a fine position map.

6. The method of claim 5, further comprising reprojecting the fine position map to three dimensions to obtain a fine face mesh.

7. The method of claim 6, further comprising:
aligning textures of the plurality of images based on the fusing of the plurality of feature maps to generate a texture map; and
applying the texture map to the fine face mesh to obtain a representation of the face.

8. The method of claim 1, wherein the common axis comprise a U, V axis.

9. The method of claim 1, plurality of images of a face comprises views of the face from a plurality of angles around the face.

10. The method of claim 1, wherein features for each image of the plurality of images are extracted using a set a machine learning based feature extractors.

11. An apparatus for generating a representation of a face, the apparatus comprising:
at least one memory; and
at least one processor coupled to the at least one memory and configured to:
obtain a plurality of images of a face;
extract features for each image of the plurality of images to generate a plurality of feature maps; and
fuse the plurality of feature maps based on features of the plurality of feature maps along a common axis to generate an aligned feature map.

12. The apparatus of claim 11, wherein the at least one processor is further configured to:
obtain a generic 3D morphable model (3DMM) of a face, the generic 3DMM including a plurality of vertices;
project the generic 3DMM to two dimensions based on the common axis to generate a mean face position map;
determine one or more correspondences between features of the aligned feature map and vertices of the mean face position map to generate a first residual position map; and
combine the first residual position map with the mean face position map to generate an intermediate position map.

13. The apparatus of claim 12, wherein, to determine the one or more correspondences, the at least one processor is further configured to determine one or more displacement values between features of the aligned feature map and vertices of the mean face position map, and wherein the first residual position map includes the one or more displacement values.

14. The apparatus of claim 12, wherein the one or more correspondences are also determined based on a label map labeling portions of the mean face position map.

15. The apparatus of claim 12, wherein the at least one processor is further configured to:
determine one or more correspondences between features of the aligned feature map and vertices of the intermediate position map to generate a second residual position map; and
combine the second residual position map with the intermediate position map to generate a fine position map.

16. The apparatus of claim 15, wherein the at least one processor is further configured to reproject the fine position map to three dimensions to obtain a fine face mesh.

17. The apparatus of claim 16, wherein the at least one processor is further configured to:
align textures of the plurality of images based on the fusing of the plurality of feature maps to generate a texture map; and
apply the texture map to the fine face mesh to obtain a representation of the face.

18. The apparatus of claim 11, wherein the common axis comprise a U, V axis.

19. The apparatus of claim 11, wherein the plurality of images of a face comprises views of the face from a plurality of angles around the face.

20. The apparatus of claim 11, wherein features for each image of the plurality of images are extracted using a set a machine learning based feature extractors.

21. A non-transitory computer-readable storage medium comprising instructions stored thereon which, when executed by at least one processor, causes the at least one processor to:
obtain a plurality of images of a face;
extract features for each image of the plurality of images to generate a plurality of feature maps; and
fuse the plurality of feature maps based on features of the plurality of feature maps along a common axis to generate an aligned feature map.

22. The non-transitory computer-readable storage medium of claim 21, wherein the instructions cause the at least one processor to:
obtain a generic 3D morphable model (3DMM) of a face, the generic 3DMM including a plurality of vertices;
project the generic 3DMM to two dimensions based on the common axis to generate a mean face position map;
determine one or more correspondences between features of the aligned feature map and vertices of the mean face position map to generate a first residual position map; and
combine the first residual position map with the mean face position map to generate an intermediate position map.

23. The non-transitory computer-readable storage medium of claim 22, wherein, to determine the one or more correspondences, the instructions cause the at least one processor to determine one or more displacement values between features of the aligned feature map and vertices of the mean face position map, and wherein the first residual position map includes the one or more displacement values.

24. The non-transitory computer-readable storage medium of claim 22, wherein the one or more correspondences are also determined based on a label map labeling portions of the mean face position map.

25. The non-transitory computer-readable storage medium of claim 22, wherein the instructions cause the at least one processor to:
determine one or more correspondences between features of the aligned feature map and vertices of the intermediate position map to generate a second residual position map; and
combine the second residual position map with the intermediate position map to generate a fine position map.

26. The non-transitory computer-readable storage medium of claim 25, wherein the instructions cause the at least one processor to reproject the fine position map to three dimensions to obtain a fine face mesh.

27. The non-transitory computer-readable storage medium of claim 26, wherein the instructions cause the at least one processor to:
align textures of the plurality of images based on the fusing of the plurality of feature maps to generate a texture map; and
apply the texture map to the fine face mesh to obtain a representation of the face.

28. The non-transitory computer-readable storage medium of claim 21, wherein the common axis comprise a U, V axis.

29. The non-transitory computer-readable storage medium of claim 21, wherein the plurality of images of a face comprises views of the face from a plurality of angles around the face.

30. The non-transitory computer-readable storage medium of claim 21, wherein features for each image of the plurality of images are extracted using a set a machine learning based feature extractors.
